(19) United States
(12) Patent Application Publication
(10) Pub. No.: US 2005/0281272 A1
(43) Pub. Date: Dec. 22, 2005

(54) Displaying virtual network properties in a graphical user interface

(76) Inventor: Sarayu S. Chandrapal, Roseville, CA (US)

Correspondence Address: HEWLETT-PACKARD COMPANY;Intellectual Property Administration, P.O. Box 272400, Fort Collins, CO, 80527-2400, US

(21) Appl. No.: 10/870,564

(22) Filed: Jun. 17, 2004

(51) Int. Cl. H04L 12/28

(52) U.S. Cl. 370/401

(57) ABSTRACT

Virtual network properties are displayed in a graphical user interface. Link activity data that describes one or more virtual-network paths is tracked. Each virtual network path data-couples two or more data-transfer components of the network and utilizes rules for restricting data transfer based on specified relations of network switching elements. The link activity data is communicated to a graphical user interface. The activity data is displayed as variable graphical features of components of the graphical user interface, the components configured to indicate the arrangement of the one or more virtual network paths.

### FIELD OF THE INVENTION

The present disclosure relates to displaying virtual network properties in a graphical user interface.

### BACKGROUND

Computers have played an increasingly important role in all manners of business and personal activities. Along with the increase in personal computing came various networks technologies that were used to connect the computers together. Computer networks have become as important as the computers themselves, providing users worldwide connectivity via infrastructures such as the Internet.

Smaller groups of computers are often grouped into local area networks (LANs). LANs are useful in sharing data and devices with a subset of trusted users. Although LANs were initially used by large enterprises and academic institutions, the use of LANs has become much more widespread. LANs are now increasingly being used in homes and small businesses to connect computers and devices together.

LANs communicate using physical and data link layer protocol such as Ethernet. These communications operate over a connecting medium (e.g., twisted pair copper wire) that may be coupled to central data components such as switches or hubs. With fairly large and complicated computer networks, various techniques have been employed to provide greater robustness, security, and performance of these types of networks. One technique of providing these advantages is the use of Virtual Local Area Networks (VLAN).

A VLAN allows a physical network to be partitioned into multiple logical networks. Computers on a logical network belong to one group called a VLAN Group. A computer can belong to more than one VLAN group. The computers on the same VLAN group can communicate with each other. However, an important feature of VLAN is that a computer cannot directly talk to, or, hear from computers that are not in the same VLAN group(s). The traffic must go through a router in order to communicate between VLANs. VLANs are important in providing isolation and security among the VLAN groups.

In many applications, VLANs are important in providing isolation and security among the VLAN groups. A VLAN can also be used to increase network performance by limiting broadcasts to smaller and more manageable broadcast domains. A VLAN group is a broadcast domain. In traditional Layer-2 switched environments, all broadcast packets go to each and every individual port of the network. With VLAN, all broadcasts are confined to those ports in a specific broadcast domain.

Other technologies can be used with or in addition to VLANs to provide network redundancy and robustness. For example the Spanning Tree Protocol (STP) allows using multiple, redundant data links to tie together various network segments. STP blocks data transmission across certain links to prevent endless loops of data packets. Similarly, meshed networks can provide multiple redundant links between devices that each act as a router. The devices in a meshed network can be used to create a self forming and self-healing ad-hoc network for data transmission.

These enhancements to standard network technologies share one aspect in common in that they use virtual data links that can exist within general purpose communications networks, such as Ethernet networks. Many monitoring and troubleshooting tools can access the characteristics of the entire network, but do not have a way to easily identify virtual network resources.

### SUMMARY

Virtual network properties are displayed in a graphical user interface. Link activity data that describes one or more virtual-network paths is tracked. Each virtual network path data-couples two or more data-transfer components of the network and utilizes rules for restricting data transfer based on specified relations of network switching elements. The link activity data is communicated to a graphical user interface. The activity data is displayed as variable graphical features of components of the graphical user interface, the components configured to indicate the arrangement of the one or more virtual network paths.

### BRIEF DESCRIPTION OF THE DRAWINGS

FIG. 1 illustrates a system having a virtual network display GUI according to various embodiments of the invention;

FIG. 2 illustrates a virtual network GUI window according to various embodiments of the invention;

FIG. 3A illustrates a network map of a GUI according to various embodiment of the invention;

FIG. 3B illustrates a of a GUI according to various embodiment of the invention;

FIG. 4 illustrates a flowchart describing a procedure for displaying virtual network resources according to embodiments of the invention; and

FIG. 5 illustrates an example computing arrangement incorporating a GUI according to various embodiments of the invention.

### DETAILED DESCRIPTION

In the following description of various embodiments, reference is made to the accompanying drawings which form a part hereof, and in which is shown by way of illustration various example manners by which the invention may be practiced. It is to be understood that other embodiments may be utilized, as structural and operational changes may be made without departing from the scope of the present invention.

In general, the present disclosure relates to providing a graphical user interface for identifying various properties of a virtual computer network Virtual network properties generally refers to those constructs used by network control elements or data-transfer element (e.g., switches, routers, bridges, repeaters, etc) that handle data based, not only the physical connectivity of the network, but on various schemes to segregate the flow of data within that network. Examples of virtual network properties include port and link properties such as-tagged port links of a virtual local area network (VLAN), spanning tree protocol (STP) blocked links, and meshed links.

VLANs are logical groups of network nodes that communicate as if they were on the same LAN. VLANs have been increasingly adopted in large network systems. VLANs are supported over IEEE 802 LAN Media Access Control (MAC) protocols. VLANs may be used in both point-to-point and shared networking arrangements. VLANs may be formed by assigning selected ports of switch to VLANs. The switch segregates data by sending data frames between ports that are members of the same VLAN, and blocking data transfers between members of different VLANs. In other arrangements, VLANS may also be implemented by inserting “tags” in data frames. The tags indicate VLAN membership of the data frame. The switch examines the tags when segregating the data packets according to VLAN membership.

Even though multiple VLANs may run on a single LAN and associated LAN hardware, traffic between VLANs is restricted. This restriction prevents VLAN users from snooping data from other VLANs and conserves bandwidth. The bandwidth conservation is due to the fact that unicast, multicast, and broadcast network traffic is only carried to network segments that serve the VLAN to which the traffic belongs.

VLAN techniques allow the use of multiple logical networks on the same data path. In contrast, technologies such as meshed networks and spanning tree protocol allow a single logical entity to utilize multiple, redundant data paths to increase reliability. Meshed networks refer to any number of nodes arbitrarily connected together with at least one loop. The mesh is formed by any nodes within the meshed network that can be reached from any other network node by at least two distinct routes. Any remaining network nodes connected to the mesh are known as “spurs.” Typically the meshed networks are formed between network switches.

Switch meshing is a load-balancing technology that enhances reliability and performance in a number of ways. Meshing provides significantly better bandwidth utilization than either Spanning Tree Protocol (STP) or standard port trunking. Meshed networks use redundant links that remain open to carry traffic, removing any single point of failure for disabling the network, and allowing quick responses to individual link failures. This also helps to maximize investments in ports and cabling. Unlike trunked ports, the ports in a switch mesh can be of different types and speeds. For example, a 10Base-FL port and a 1 Gps port can be included in the same switch mesh.

By using multiple switches redundantly linked together to form a meshed switch domain, switch meshing dynamically distributes traffic across load-balanced switch paths by seeking the fastest paths for new traffic between nodes. In actual operation, the switch mesh periodically determines the best (lowest latency) paths, then assigns these paths as the need arises. The path assignment remains until the related Media Access Control (MAC) address entry times out. The mesh sees later traffic between the same nodes as new traffic, and may assign a different path, depending on conditions at the time.

Because redundant paths in a mesh are active, meshing adjusts quickly to link failures. If a link in the mesh fails, the fast convergence time designed into meshing typically has an alternate route selected in less than a second for traffic that was destined for the failed link.

Meshing allows scalable responses to increasing bandwidth demand. As more bandwidth is needed in a LAN backbone, another switch and another set of links can be added. This means that bandwidth is not limited by the number of trunk ports allowed in a single switch.

Similar to mesh networks, networks utilizing STP take advantage of redundant paths to increase network availability. Technologies such as Ethernet require that only one active path exist between any two nodes on the network. If there are redundant active paths on an Ethernet network, this may cause “looping,” which is the sending of redundant data packages. The redundant data resulting from the loops can quickly overcome network bandwidth.

To alleviate the potential for loops, STP utilizes communications between all participating switches in an extended LAN. The switches all exchange data messages to determine the state of other switches in the network. These messages are known as bridge protocol data units (BPDUs). STP uses the messages exchanges to election of a unique root switch. The root switch forms the base of a spanning-tree of all participating switches. For every switched LAN segment, one active switch is designated. If any loops are found, redundant switch ports are placed in a backup state.

Typically, virtual network properties are determined by connecting to a network device using a text based protocol such as telnet. From a telnet session, various command line utilities can be used to determine the state of switches, routers, wireless access points, and various other devices. Command line tools give detailed and useful information. However, it is time consuming to telnet into various entities and so this method is not useful for continuous monitoring of network activities.

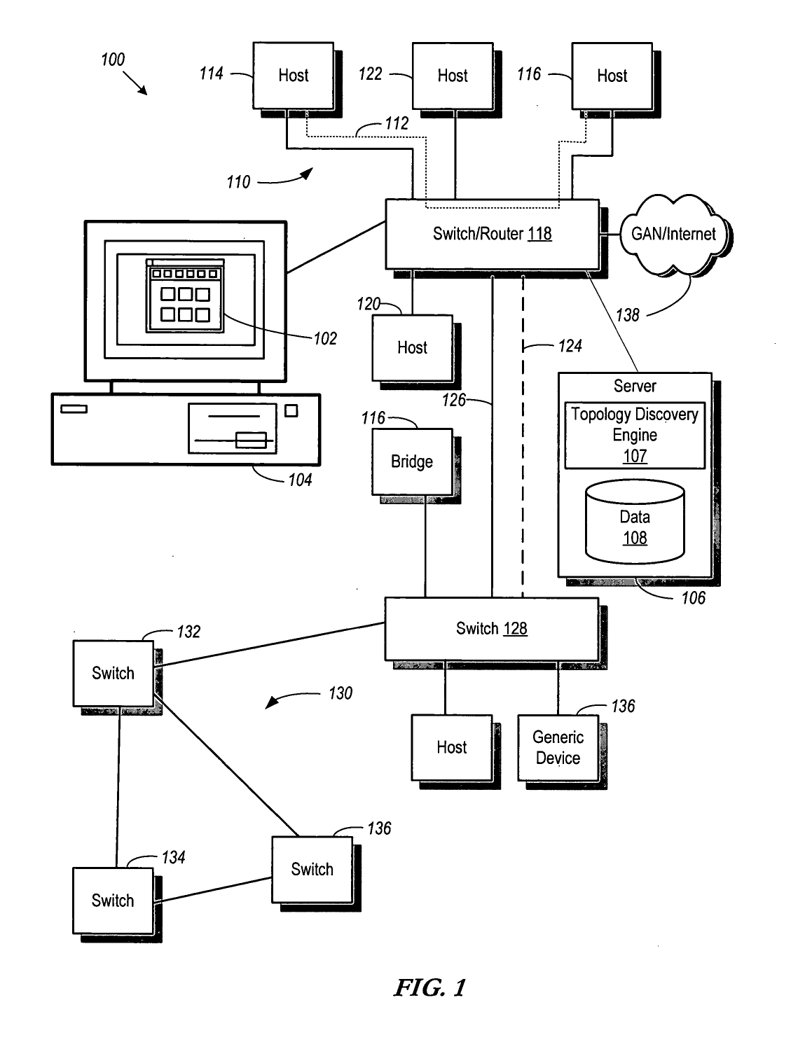

It will be appreciated that a graphical user interface (GUI) may provide a useful indication of various virtual network entities. Referring now to FIG. 1, a system 100 according to embodiments of the present invention is used to provide a GUI 102 display of virtual network elements. The GUI 102 can run on any processing device having a graphical interface such as a desktop computer 104.

The desktop computer 104 may discover network data either directly or via a remotely accessed server 106. The desktop computer 104 may run a remote management station with both the server 106 and the GUI client 102 running on the same machine, or may only have the remote GUI client 102 installed on it. The desktop computer 104 gathers information about the network via a topology discovery engine 107 that populates the database. The network information may be gathered by the topology engine 107 using such network management protocols as Cisco Discovery Protocol, (CDP), Foundry Discovery Protocol (FDP), Address Resolution Protocol (ARP) tables, Simple Network Management Protocol (SNMP), and ping sweeps. The network data may be used to populate a database 108. The GUI 102 may access the database 108 for determining various virtual network properties.

In some instances, the network information gathered by the topology engine 107 may not be accessible by the various network management protocols. However, such information may be discovered via a remote access command line session, such as telnet, secure shell (ssh), etc. Such data can be manually or automatically gathered and used to supplement data gathered by the tracking engine 107. Techniques for supplementing network management data via a command line session are described in the concurrently filed and commonly assigned patent application entitled, “Gathering Network Management Data Using A Command Line Function,” by Mohamed Hamedil, having attorney docket number 200316364-1, which is hereby incorporated by reference in its entirety.

One of the virtual network properties accessed for display in the GUI 102 are the links belonging to one or more VLANs 110. A VLAN is a group of ports designated by the switch as belonging to the same broadcast domain. That is, ports carrying traffic to a particular subnet address would belong to the same VLAN. The VLAN 110 is represented by a path 112 between a subset of network nodes. In this example, the VLAN path 112 is between hosts 114 and 116. Even though these hosts 114, 116 are on the same switch 118 as other hosts 120, 122, data routed on the VLAN 110 will be treated as if hosts 114 and 116 were on physically separate networks from the other nodes 120, 122.

Another virtual network property that may be displayed in the GUI 102 is the existence of a STP blocked path 124. The STP blocked path 124 may exist between two or more network elements (e.g., switches 118 and 128) that have redundant data paths (e.g., paths 124, 126). One path 124 is placed in a standby state whereby no data is sent using the switch ports of the STP blocked path 124.

The GUI 102 may also display virtual characteristics of a meshed network 130. The meshed network, 130, includes switches 132, 134, and 136 connected into a loop. The links between the nodes 132, 134, and 136 utilize special protocols to prevent transmission of redundant data.

It will be appreciated that the GUI 102 may contain representation of virtual or actual network elements, including routers 118, switches 128, hosts 114, data links 126, or any other network element as represented by generic device 136. The GUI 102 may provide representations of paths or devices that are coupled to external networks, such as the GAN/Internet 138.

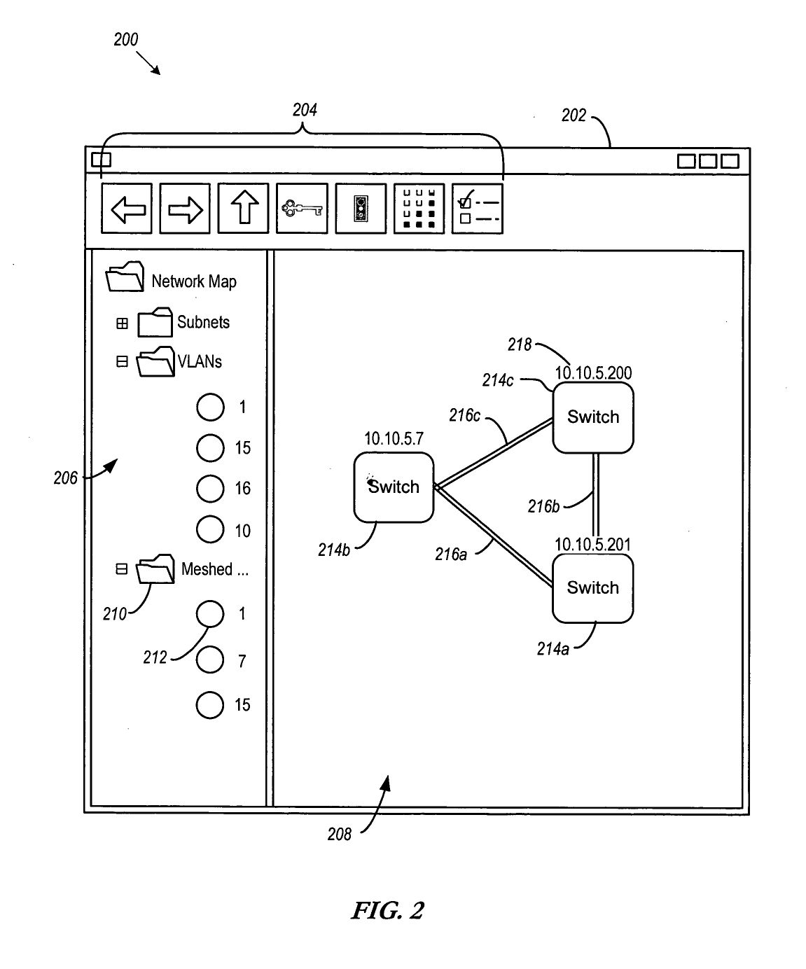

An example GUI 200 representation according to embodiments of the present invention is shown in FIG. 2. The GUI 200 may be presented in a window 202 of a computerized graphical display, such those provided by Microsoft Windows™ operating system, X Windows™ etc. The GUI window 202 may include features such as a toolbar 204 that may be used to quickly invoke actions related to the GUI 200.

The graphical display of virtual network data may include various data model views, including a hierarchical display 206 and a map display 208. The hierarchical display 206 provides a paradigm for showing relationships in a hierarchical tree. Typically, the hierarchical display 206 includes container components 210 and data components 212. The container components 210 are used for organizing data in a hierarchical fashion, and can be graphically represented as file folders. The data components 212 represent the actual data, and may have different graphical representations depending on the type of data. In the illustrated example, the data component 212 represents a meshed node on the network.

The hierarchical display 206 may be used to control and/or display characteristics of network elements. For example, the components 210, 212 may include labels that are descriptive of the network elements associated with the components 210, 212. The components 210, 212 may have context sensitive menus (e.g., right-mouse menus) for accessing functionality related to the associated network elements. The hierarchical display 206 may also be used to control other portions of the GUI 200. For example, selecting one or more components 210, 212 may result in limiting the graph display 208 to show only representations of the network elements associated with the components 210, 212.

The map display 208 includes graphical elements that illustrate the functional layout of virtual network elements. The functional layout is typically represented as a graph. The network may be represented in the map display 208 as components 214a-c and links 216a-c. The components 214a-c are typically represented by closed shapes such as rectangles. The node components 214a-c may contain any combination of text and graphics to describe an associated network entity. Additional annotations may also be included with the node components 214a-c, such as a text component 218 that represents an IP address of the associated network entity 214c.

The-links 216a-c, represent virtual data paths between switches 214a-c. The links 216a-c may have different characteristics depending on the type of virtual connection represented by the arcs 216a-c. In this example, the double-lines 216a-c are used to represent meshed links. It will be appreciated that any combination of graphical characteristics may be used to indicate the type of virtual links represented by the arcs, including color, line thickness, text annotations, etc. In addition, multiple line characteristics may be combined to indicate multiple characteristics of the associated link. For example, the type of link may be indicated by the line color, and the maximum bandwidth of the link may be indicated by line thickness.

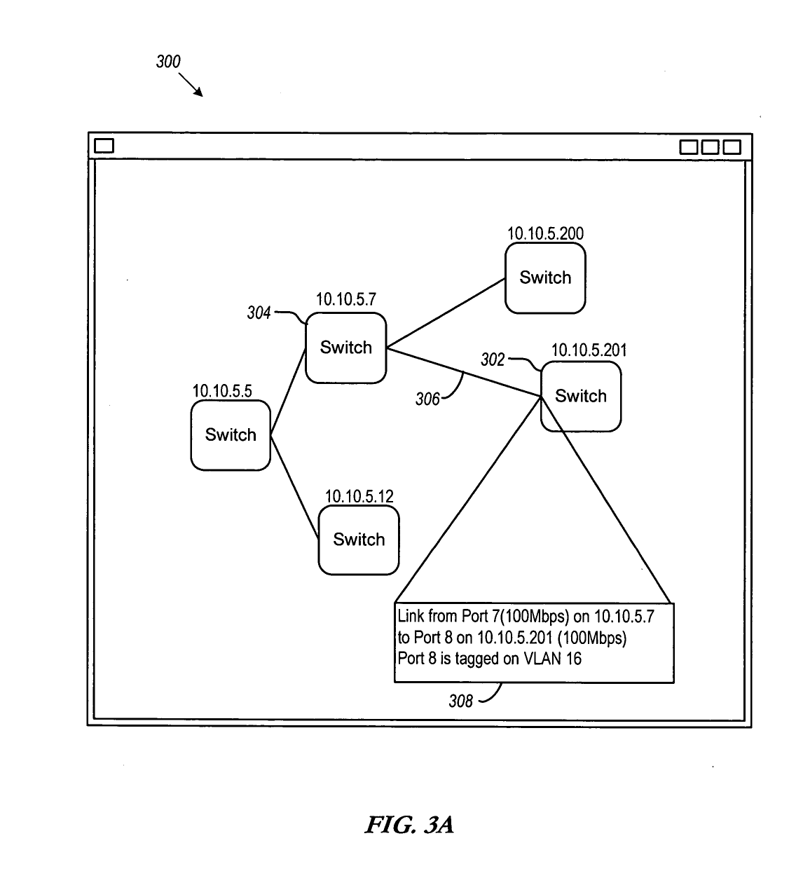

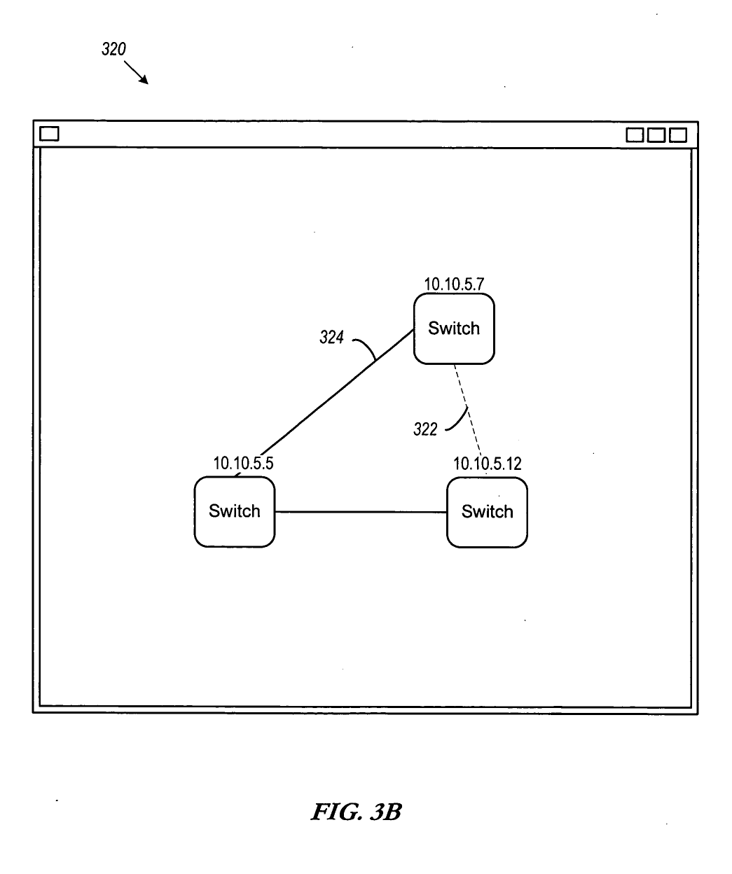

Display of VLAN links and STP blocked links are shown in FIGS. 3A and 3B. FIG. 3A shows a VLAN map display 300 according to various embodiments of the present invention. In this map display 300, network components (e.g., switches 302, 304) are connected by VLAN links (e.g., link 306) represented as single lines. The map display 300 also includes an information dialog 306, which may be dynamically displayed by user input (e.g., mouse motion or click).

The information dialog 308 may provide information about links 306 or network components 302, 304 of the map display 300. The illustrated information dialog 308 includes information regarding tagged ports. Tagged ports are those that utilize tag data that may optionally be added to data frames. The tag data explicitly classifies the frame as belonging to a particular VLAN. It will be appreciated that information dialogs may be included with any GUI elements described herein.

FIG. 3B shows a network map 320 with blocked STP links according to embodiments of the present invention. The dashed line 322 in this example represents a blocked STP link, and the solid line 324 represents the active link associated with the blocked STP link 322.

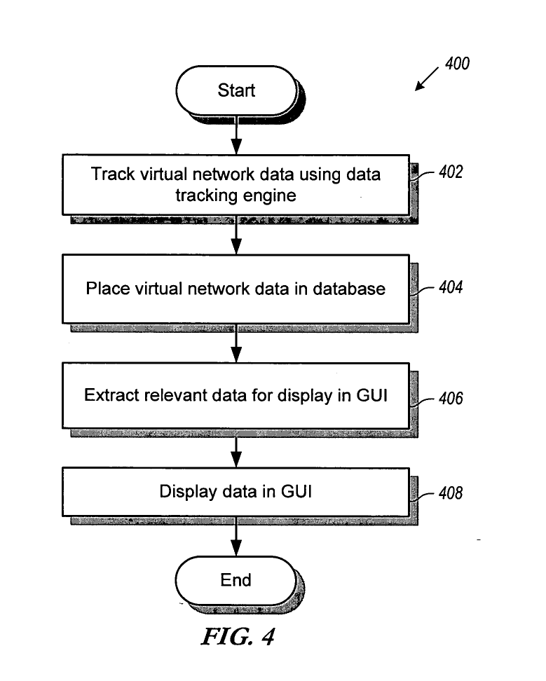

In reference now to FIG. 4, a flowchart 400 illustrates a procedure for displaying virtual network properties in a GUI. First, the virtual network data is tracked (402) using a topology discovery engine. The topology discovery engine may run in a different thread of execution from the GUI, or on and entirely different computer (e.g., a server) than the GUI. Typically, the topology discovery engine will continuously track (402) data in parallel with other data collection functions.

The tracking engine may place (404) virtual network data into a database. The database may be any form of locally connected or remote shared memory, including random-access memory, filesystem, relational database, etc. The shared nature of the database allows the GUI to asynchronously extract (406) relevant data for display (408). The GUI may be updated by repeatedly extracting (406) and displaying (408) the virtual network data at a set time interval, as well as responding directly to user or system events (e.g., queries, refresh request, updates from tracking engine).

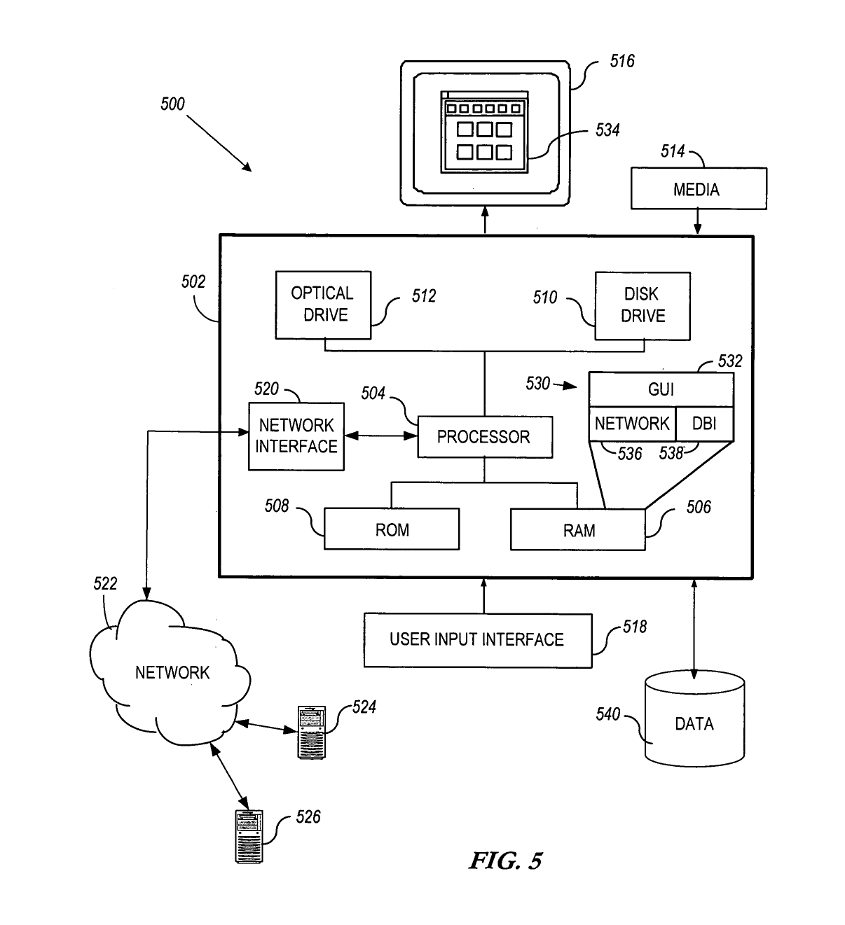

The procedures described herein for providing a virtual network GUI interface may be implemented by any manner of data processing arrangement known in the art. FIG. 5 shows a data processing arrangement 500 configured for displaying virtual network configurations according to various embodiments of the present invention. The arrangement 500 includes a computing apparatus 502 with a processor 504 and coupled to some form of data storage. The data storage may include volatile memory such as RAM 506. Other devices that the apparatus 502 may use for data storage and retrieval include a ROM 508, disk drive 510, optical drive 512, and removable media 514.

A display 516 and user-input interface 518 may be attached to the computing apparatus 502 to allow user data input and display output. The computing apparatus 502 includes a network interface 520 that allows the apparatus to communicate with other computing devices 524, 526 across a network 522.

The computing apparatus 502 may contain one or more software module 530 used for gathering and displaying network information. The software modules 530 may include a GUI module 532 used for displaying the GUI 534 in the display 516, as well as processing user input from the input interface 518. The GUI module 532 may provide alternate ways of displaying the GUI 534, such as, providing remotely accessible graphics using Web based technologies (e.g., Java™, Flash™, Shockwave™, etc.) or other network graphics technologies (e.g., X Windows®).

The network information shown in the GUI 534 may be gathered via a network interface module 536. The network interface module 536 may include the ability to use various network topology discovery protocols as described herein, or to gather data/status by interfacing with a locally or remotely operating network tracking engine. The topology data gathered by the network interface module 536 may be used directly by the GUI module 534 or be placed in a database 540 via a database interface 538. The database 540 may be used for short-term caching and long-term persistent storage of network data.

Computer-executable instructions that perform functionality of the various modules 530 may be provided as software on any computer-readable medium, such as a diskette or a CD-ROM. The software may also be provided locally or remotely via a data transfer interface such as the network interface 520.

From the description provided herein, those skilled in the art are readily able to combine hardware and/or software created as described with appropriate general purpose or system and/or computer subcomponents embodiments of the invention, and to create a system and/or computer subcomponents for carrying out the method embodiments of the invention. Embodiments of the present invention may be implemented in any combination of hardware and software.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention not be limited with this detailed description, but rather the scope of the invention is defined by the claims appended hereto.

1. A processor-based method for representing network activity in a network, comprising:
providing access to a plurality of data transfer components that transfer data between network nodes;
tracking link activity data that describes one or more virtual network paths, each virtual network path coupling two or more of the data-transfer components, wherein data transferred via the virtual network paths is restricted based on specified relations of network switching elements;
communicating the link activity data to a graphical user interface; and
displaying the activity data as variable graphical features of components of the graphical user interface, the components configured to indicate the arrangement of the one or more virtual network paths.

2. The method of claim 1, wherein the virtual network paths comprise data links of a virtual local area network (VLAN).

3. The method of claim 1, wherein the virtual network paths are defined using VLAN tags inserted into data frames transferred via the virtual network paths.

4. The method of claim 1, wherein the virtual network paths comprise one or more redundant links that are blocked from transferring data according to a spanning-tree protocol.

5. The method of claim 1, wherein the virtual network paths comprise one or more redundant links that transfer data according to a mesh network protocol.

6. The method of claim 1, wherein displaying the activity data as variable graphical features comprises displaying the virtual network paths as arcs and displaying network components connected by the paths as closed shapes.

7. The method of claim 1, wherein displaying the activity data as variable graphical features comprises displaying in a hierarchical tree structure references to the virtual network paths.

8. The method of claim 1, wherein tracking link activity data comprises gathering network status data using a network management protocol.

9. The method of claim 8, wherein tracking link activity data further comprises supplementing the network status data with data gathered by remotely executing a command line function on one or more of the data transfer components.

10. A system, comprising:
a plurality of computing arrangements coupled via a network and arranged to communicate via one or more virtual network paths, each virtual network path utilizing rules for restricting data transfer via the virtual network paths within the network;
a tracking engine coupled to the network and configured to gather, via the network, tracking data describing the virtual network paths; and
a graphical user interface coupled to the tracking engine and configured to display graphical components that indicate the arrangement of the one or more virtual network paths based on tracking data gathered by the tracking engine.

11. The system of claim 10, wherein the virtual network paths comprise links of a virtual local area network (VLAN).

12. The system of claim 10, wherein the virtual network paths are defined using VLAN tags inserted into data frames transferred via the virtual network paths.

13. The system of claim 10, wherein the virtual network paths comprise one or more redundant links that are blocked from transferring data according to a spanning-tree protocol.

14. The system of claim 10, wherein the virtual network paths comprise one or more redundant links that transfer data according to a mesh network protocol.

15. The system of claim 10, wherein the tracking engine gathers network status data using a network management protocol.

16. The system of claim 15, wherein the tracking engine supplements the network status data with data gathered by remotely executing a command line function on one or more of the data transfer components.

17. A processor-readable medium, comprising:
a program storage device configured with instructions for causing a processor of a data processing arrangement to perform the operations of,
providing access to a plurality of data transfer components that transfer data between network nodes;
tracking link activity data that describes one or more virtual network paths, each virtual network path coupling two or more of the data-transfer components, wherein data transferred via the virtual network paths is restricted based on specified relations of network switching elements;
communicating the link activity data to a graphical user interface; and
displaying the activity data as variable graphical features of components of the graphical user interface, the components configured to indicate the arrangement of the one or more virtual network paths.

18. The processor-readable medium of claim 17, wherein the virtual network paths comprise links of a virtual local area network (VLAN).

19. The processor-readable medium of claim 17, wherein the virtual network paths are defined using VLAN tags inserted into data frames transferred via the virtual network paths.

20. The processor-readable medium of claim 17, wherein the virtual network paths comprise one or more redundant links that are blocked from transferring data according to a spanning-tree protocol.

21. The processor-readable medium of claim 17, wherein the virtual network paths comprise one or more redundant links that transfer data according to a mesh network protocol.

22. The processor-readable medium of claim 17, wherein tracking link activity data comprises gathering network status data using a network management protocol.

23. The processor-readable medium of claim 22, wherein tracking link activity data further comprises supplementing the network status data with data gathered via a remotely executed command line function on one or more of the data transfer components.

24. A system comprising:
means for providing access to a plurality of data transfer components that transfer data between network nodes;
means for tracking link activity data that describes one or more virtual network paths, each virtual network path coupling two or more of the data-transfer components, wherein data transferred via the virtual network paths is restricted based on specified relations of network switching elements;
means for communicating the link activity data to a graphical user interface;
means for displaying the activity data as variable graphical features of components of the graphical user interface, the components configured to indicate the arrangement of the one or more virtual network paths.

25. The system of claim 24, further comprising means for supplementing the network link activity with data gathered via a remotely executed command line function on one or more of the data transfer components.
